(19) United States
(12) Patent Application Publication
(10) Pub. No.: US 2026/0119887 A1
(43) Pub. Date: Apr. 30, 2026

(54) GRAPH RECURSIVE CONVOLUTION LAYERS

(71) Applicant: X Development LLC, Mountain View, CA (US)

(72) Inventors: Avery Noam Cowan, Atherton, CA (US); Akshina Gupta, Warren, NJ (US)

(21) Appl. No.: 19/003,970

(22) Filed: Dec. 27, 2024

Related U.S. Application Data
(60) Provisional application No. 63/616,495, filed on Dec. 29, 2023.

(51) Int. Cl. G06N 3/09; G06N 3/042; G06N 3/048

(52) U.S. Cl. CPC G06N 3/09; G06N 3/042; G06N 3/048

(57) ABSTRACT

Methods, systems, and apparatus, including medium-encoded computer program products, for processing data representing a graph through each of a plurality of layers of a graph neural network to generate an output. The plurality of layers include a graph recursive convolutional layer.

### RELATED APPLICATION

This application claims priority under 35 U.S.C. § 119(e) to U.S. Provisional Application Ser. No. 63/616,495, filed on Dec. 29, 2023, the disclosures of which are incorporated herein by reference in their entirety.

### BACKGROUND

This specification relates to neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

Some neural networks are graph neural networks (GNNs). A graph neural network is a type of neural network that operates on structured data represented as graphs. For example, a graph can represent a power grid or electrical grid.

A power grid or electrical grid is an interconnected network for delivering electricity from producers to consumers. A power grid typically includes various pieces of equipment or assets. For example, a power system may include one or more generators, one or more substations, power transmission lines, and power distribution lines. A generator or generating station may generate electric power from sources of primary energy or may convert motive power into electrical power for transmission to a power electrical grid. A substation may be a part of an electrical generation, transmission, and distribution system. Substations may transform voltage from high to low, or the reverse, or perform any of several other functions. Between a generating station and consumer, electric power may flow through several substations at different voltage levels. A substation may include transformers to change voltage levels between high transmission voltages and lower distribution voltages, or at the interconnection of two different transmission voltages. Electric power transmission lines may facilitate bulk movement of electrical energy from a generating site, such as a power plant including one or more generators, to one or more electrical substations. The interconnected lines which facilitate this movement are known as a transmission network. Electric power distribution is the final stage in the delivery of electric power; it carries electricity from the transmission system to individual consumers. Distribution substations connect to the transmission system and lower the transmission voltage to medium voltage through the use of transformers. Primary distribution lines carry this medium voltage power to distribution transformers located near the customer's premises. Distribution transformers again lower the voltage to the utilization voltage used by lighting, industrial equipment or household appliances. Often several customers are supplied from one transformer through secondary distribution lines. Commercial and residential customers are connected to the secondary distribution lines through service drops.

### SUMMARY

This specification describes a system implemented as computer programs on one or more computers in one or more locations that performs a machine learning task on an input that includes graph data defining a graph to generate an output. To perform the machine learning task, the system includes a graph neural network. The graph neural network includes a graph recursive convolution layer that updates an initial embedding for each node in the graph by making multiple calls to a recursive function to traverse at least a portion of the graph beginning from the node and ending at one or more leaf nodes of the graph.

In general, innovative aspects of the subject matter described in this specification can be embodied in methods that include the actions of receiving a layer input for the graph recursive convolution layer that includes an initial embedding for each of the plurality of nodes in the graph, and, for a particular node in the plurality of nodes: generating a combined embedding for the particular node based on an initial embedding for the particular node and on respective initial embeddings for one or more leaf nodes of the graph, and generating an updated embedding for the particular node based on applying a graph convolution function to the combined embedding for the particular node. And, generating, from at least the updated embedding for the particular node in the plurality of nodes, a layer output for the graph recursive convolution layer. Other implementations of this aspect include corresponding systems, apparatus, and computer programs, configured to perform the actions of the methods, encoded on computer storage devices.

These and other implementations can each optionally include one or more of the following features.

In some implementations, generating the combined embedding for the particular node includes making a call to a recursive function by passing a child node of the particular node as an argument to the recursive function.

In some implementations, generating the combined embedding for the particular node includes making another call to the recursive function if the child node is not a leaf node in the graph.

In some implementations, generating the combined embedding for the particular node includes determining a combination of respective updated embeddings for child nodes of the particular node.

In some implementations, determining the combination of respective updated embeddings for child nodes of the particular node includes determining a weighted summation of the updated embeddings weighted by weight terms defined by edges that connect the child nodes to the particular node.

In some implementations, generating the combined embedding for the particular node includes concatenating the combination of respective updated embeddings for child nodes of the particular node to the initial embedding for the particular node.

In some implementations, applying the graph convolution function includes: computing a multiplication between (i) a weight matrix and (ii) the combined embedding for the particular node to generate a multiplication product; adding a bias vector to the multiplication product to generate an intermediate output of the graph convolution function; and applying an activation function to the intermediate output of the graph convolution function to generate the updated embedding for the particular node.

In some implementations, the graph is a directed acyclic graph.

Some implementations include processing the layer output for the graph recursive convolution layer using other layers in the plurality of layers to generate the output of the graph neural network.

In some implementations, the other layers include one or more graph convolution layers and one or more pooling layers.

Particular embodiments of the subject matter described in this specification can be implemented so as to realize one or more of the following advantages. This specification describes techniques that improve the performance, e.g., accuracy, of a graph neural network on any of a variety of machine learning tasks that operate on a graph with minimal additional memory overhead. A recursive graph convolution layer as described in this specification can incorporate a larger amount of information from other nodes in the graph into the embedding for each node in the graph by traversing a larger number of nodes in the graph, compared to an existing graph convolution layer. In particular, the graph recursive convolution layer incorporates information from not only the immediate neighbor nodes of a given node, but also information from distant nodes, including leaf nodes in the graph. A graph neural network that has the recursive graph convolution layer can thus achieve high performance on tasks that involve collective, e.g., rather than segmented or piece-wise, analysis of an entire graph, and tasks that involve processing multiple graphs having variable sizes.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example graph neural network system.

FIG. 2 shows an example of the operations performed by a graph recursive convolution layer.

FIG. 3 shows example pseudo code to implement a recursive function for a graph recursive convolution layer.

FIG. 4 is a flow diagram of an example process for processing a layer input by a graph recursive convolution layer to generate a layer output.

FIG. 5 is a flow diagram of sub-steps of one of the steps of the process of FIG. 4.

FIG. 6 is a block diagram of an example computer system.

Like reference numbers and designations in the various drawings indicate like elements.

### DETAILED DESCRIPTION

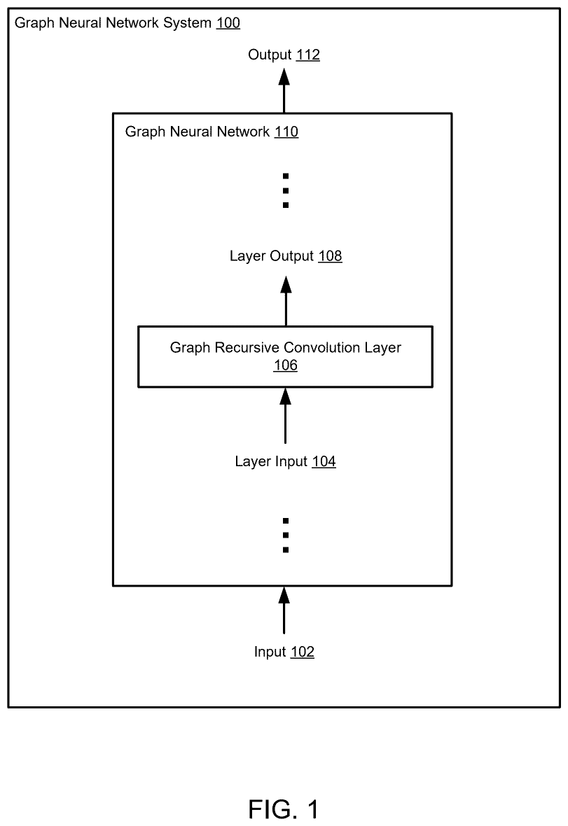

FIG. 1 shows an example graph neural network system 100. The graph neural network system 100 is an example of a system implemented as computer programs on one or more computers in one or more locations, in which the systems, components, and techniques described below can be implemented.

The graph neural network system 100 can receive an input 102 that includes graph data defining a graph and perform a machine learning task on the input 102 to generate an output 112. A “graph” refers to a data structure that includes at least: (i) a set of nodes, and (ii) a set of edges. Each edge in the graph can connect a pair of nodes in the graph. The graph data thus includes node data defining nodes of the graph, and edge data defining edges of the graph. For example, the graph can be represented as, e.g., G=(V, E), where V is the set of nodes and E is the set of edges.

The nodes in the graph represent objects and their attributes, and edges between the nodes represent connections, relationships, or other associations between the objects. The objects themselves can be any entity for which connections, relationships, or associations with other objects is to be modeled by the graph. The objects can represent real or virtual objects. Real object are objects that have a physical, tangible existence. For example, a real object can represent a real-world system. Virtual objects are objects that exist in digital representations. For example, a virtual object can represent data stored in a database, an executable program, or a software application. These objects have associated attributes which define the objects themselves. The attributes may be of many different types depending upon the particular object.

Generally, the graph included in the input 102 can represent any appropriate type of system, e.g., an electric power grid, a power generating system, a social network, a collection of particles, or a point cloud. The machine learning task can be any machine learning task that operates on a graph. Examples of systems that can be represented by the graph, and examples of tasks that can be performed by the graph neural network system 100 on the graph are described in more detail below.

As a particular example, the graph can represent a power grid or an electrical grid. Each node in the graph represents a component of the electric grid, and each edge represents a connection between components of the electric grid. In this example, the machine learning task can be a task to predict any appropriate property or aspect of the power grid represented by the graph. For example, the output 112 can include, for each of one or more nodes and edges included in the graph, a predicted classification of the asset represented by the node or edge, e.g., for a set of nodes and edges, the output 112 can specify whether the set of nodes and edges represents a transformer. As another example, the output 112 can include data characterizing the predicted electrical properties of the components and the connections represented by the nodes and edges, respectively. Electrical properties include, for example, phasing, power rating, line impedance, and line length of the one or more connection paths. As yet another example, the output 112 can include a connectivity prediction (e.g., whether there is a connection) for each of a plurality of edges each connecting a pair of the plurality of nodes.

The graph neural network system 100 can thus be included as a part of, or used by, a power grid simulator that simulates operations of a power grid to obtain simulation results for the power grid. Simulation results can include, for example, time-varying values of electrical characteristics of the power grid under simulated operating conditions. To obtain the simulation results, the power grid simulator performs a simulation of power grid operations of the power grid based on the properties of its components that have been predicted by the graph neural network system 100 from the graph.

As another example, the graph can represent a point cloud (e.g., generated by a lidar or radar sensor), each node in the graph can represent a respective point in the point cloud, and the output 112 can include a prediction of a class of object represented by the point cloud.

As another example, the graph can represent a portion of text, each node in the graph can represent a respective word in the portion of text, and the output 112 can include a prediction of the portion of text, e.g., a sentiment expressed in the portion of text, e.g., positive, negative, or neutral.

As another example, the graph can represent an image, each node in the graph can represent a respective portion of the image (e.g., a pixel or a region of the image), and the output 112 can include a characterization of the image, e.g., a class of object depicted in the image.

As another example, the graph can represent an environment in the vicinity of a partially- or fully-autonomous vehicle, each node in the graph can represent a respective agent in the environment (e.g., a pedestrian, bicyclist, vehicle, etc.) or an element of the environment (e.g., traffic lights, traffic signs, road lanes, etc.), and the output 112 can include a prediction of, e.g., a respective future trajectory of one or more of the agents represented by nodes in the graph. For example, the output 112 can characterize a respective likelihood that a vehicle agent represented by a node in the graph will make one or more possible driving decisions, e.g., going straight, changing lanes, turning left, or turning right.

As another example, the graph can represent a social network (e.g., on a social media platform), each node in the graph can represent a respective person in the social network, each edge in the graph can represent, e.g., a relationship between two corresponding people in the social network (e.g., a “follower” or “friend” relationship), and the output 112 can include a prediction of, e.g., which people in the social network are likely to perform a certain action in the future (e.g., purchase a product or attend an event).

As another example, the graph can represent a road network, each node in the graph can represent a route segment in the road network, each edge in the graph can represent that two corresponding route segments are connected in the road network, and the output 112 can include a prediction of, e.g., a time required to traverse a specified path through the road network, or an amount of traffic on a specified path through the road network.

As another example, the graph can be a computational graph that represents, e.g., computational operations performed by a neural network model, each node in the graph can represent a group of one or more related computations (e.g., operations performed by a group of one or more neural network layers), and each edge in the graph can represent that an output of one group of computations is provided as an input to another group of computations. In these examples, and the output 112 can include a prediction of, e.g., a respective computing unit (i.e., from a set of available computing units) that should perform the operations corresponding to each node in the graph, e.g., to minimize a time required to perform the operations defined by the graph. Each computing unit can be, e.g., a respective thread, tensor processing unit (TPU), central processing unit (CPU), or graphics processing unit (GPU). Thus, in this example, the graph neural network system 100 can perform operations that assign computational operations to physical or logical computing units. The graph neural network system 100 can identify a respective computing unit that should perform the operations corresponding to each node in the graph.

As another example, the graph can represent a protein, each node in the graph can represent a respective amino acid in the amino acid sequence of the protein, and each edge in the graph can represent that two corresponding amino acids in the protein are separated by less than a threshold distance in a structure of the protein. In this example, the output 112 can include a prediction of, e.g., a stability of the protein, or a function of the protein.

As another example, the graph can represent a knowledge base, each node in the graph can represent a respective entity in the knowledge base, and each edge in the graph can represent a relationship between two corresponding entities in the knowledge base. In these examples, the output 112 can include a prediction of, e.g., missing features associated with one or more entities in the knowledge base.

To perform any of these tasks, the graph neural network system 100 includes a graph neural network 110 that includes multiple layers that include a graph recursive convolution layer 106. Although one graph recursive convolution layer 106 is depicted in FIG. 1 for convenience, the graph neural network 110 generally includes many other layers, including, for example, pooling layers, fully connected layers, graph convolution layers, and other graph recursive convolution layers.

For example, the graph neural network 110 can include one or more graph recursive convolution layers interleaved within a stack of graph convolution layers. As a particular example, the graph neural network 110 can include a graph convolution layer, followed by the graph recursive convolution layer 106, followed by one or more graph convolution layers, followed by another graph recursive convolution layer, followed by one or more graph convolution layers, and followed by a global pooling layer, e.g., a maximum pooling layer, a minimum pooling layer, or an average pooling layer.

The graph recursive convolution layer 106 receives a layer input 104 and operates on the layer input 104 in accordance with a layer-wise aggregate-and-update rule to generate a layer output 108. The layer input 104 can generally be any intermediate data generated by the graph neural network 110 when performing the machine learning task on the input 102 that includes graph data defining a graph to generate the output 112.

For example, the layer input 104 can include, for each of one or more nodes included in the graph, an initial embedding for the node that is generated by a preceding layer, e.g., a graph convolution layer or another layer, in the graph neural network 110. An “embedding” as used in this specification is a vector (or another data structure) of numeric values, e.g., floating point values or other values, that has a predetermined dimensionality. The initial embedding for the node can, for example, represent feature information of node that is extracted by the preceding layer.

In this example, the graph convolution layer receives a layer input and operates on the layer input in accordance with a layer-wise aggregate-and-update rule that is different from the layer-wise aggregate-and-update rule used by the graph recursive convolution layer 106 to generate a layer output that includes the updated embedding for each of one or more nodes included in the graph. The updated embeddings included in the layer output of the graph convolution layer will then be used as the initial embeddings to be included in the layer input 104 to the graph recursive convolution layer 106, which is arranged subsequent to the graph convolution layer.

Conventionally, for a given node v included in the graph G=(V, E), the layer-wise aggregate-and-update rule for a graph convolution layer may be referred to as a “local” aggregate-and-update rule because it aggregates information from the immediate neighbor nodes of the given node v, and uses the aggregated information to update the embedding for the given node v.

Equation 1 is an example graph convolution function that can be used by the local aggregate-and-update rule for a graph convolution layer:

$${ϕ}_{G C L} ( {W}_{G C L} {\sum }_{u ∈ N ( v )} {x}_{u} + {b}_{G C L} ) , \qquad Equation 1$$

where φ_{GCL} denotes an activation function, W_{GCL} represents a weight matrix and b_{GCL} represents a bias vector, and W_{GCL} and b_{GCL} are trainable parameters of the graph convolution layer.

For a given node v, Equation 1 can be applied to a layer input to generate as output the updated embedding for the given node v. In Equation 1, Σ_{u∈N}(v) xᵤ represents the layer input to the graph convolution layer. The layer input Σ_{u∈N}(v) xᵤ includes feature information from the nodes included in the immediate neighborhood N(v) of the given node v. A node included in the immediate neighbor may be referred to as an immediate neighbor node. The immediate neighbor node of a given node is a node that is connected to the given node by one (and exactly one) edge.

In Equation 1, the layer input Σ_{u∈N}(v) xᵤ to the graph convolution layer is a summation of the initial embeddings x for the nodes included in the immediate neighborhood N(v) of the given node v. The size of the immediate neighborhood N(v) (the total number of immediate neighbor nodes of the given node) is generally smaller, and oftentimes much smaller, than the size of V (the total number of nodes included in the graph). That is, there could be a large number of nodes included in the graph that are outside of the immediate neighborhood N(v) of the given node v, i.e., that are connected to the given node v through two or more edges.

The graph recursive convolution layer 106, however, operates in accordance with a different layer-wise aggregate-and-update rule. For a given node v included in the graph G=(V, E), the layer-wise aggregate-and-update rule for a graph recursive convolution layer may be referred to as a “global” aggregate-and-update rule because it aggregates feature information from a larger number of nodes (e.g., all of the nodes) included in the graph, and uses the aggregated feature information to update the embedding for the given node v.

In particular, for the given node v, the layer-wise aggregate-and-update rule for the graph recursive convolution layer aggregates feature information from nodes that include distant nodes, e.g., leaf nodes, in the graph that are connected to the given node v through two or more edges, and are thus outside of the immediate neighborhood of the given node v. This is in contrast to the local aggregate-and-update rule for the graph convolution layer, which merely aggregates feature information from the nodes included in the immediate neighborhood of the given node v.

Equation 2 is an example graph convolution function that can be used by the global aggregate-and-update rule for a graph recursive convolution layer:

$${ϕ}_{G R C L} ( {W}_{G R C L} {z}_{G R C L} + {b}_{G R C L} ) , \qquad Equation 2$$

where φ_{GRCL} denotes an activation function, W_{GRCL} represents a weight matrix and b_{GRCL} represents a bias vector, and both W_{GRCL} and b_{GRCL} are trainable parameters of the graph recursive convolution layer. The activation function φ_{GRCL} can be any conventional activation function, e.g., ReLU, sigmoid, or tanh.

The global aggregate-and-update rule for the graph recursive convolution layer differ from the local aggregate-and-update rule for the graph convolution layer at least in the number of times a graph convolution function is applied and, correspondingly, in the inputs on which the graph convolution function is applied.

More specifically, for a given node v, Equation 2 can be recursively applied to a respective input across a recursive procedure to generate as output the updated embedding for the given node v. In Equation 2, z_{GRCL} represents the input to the graph recursive convolution layer. In the first step of the recursive procedure, the input can include feature information from the nodes included in the immediate neighborhood N(v) of the given node v. Then, in the second step of the recursive procedure, the input can include feature information from the nodes included in the immediate neighborhood of one of the immediate neighbor nodes u of the given node v. And so on.

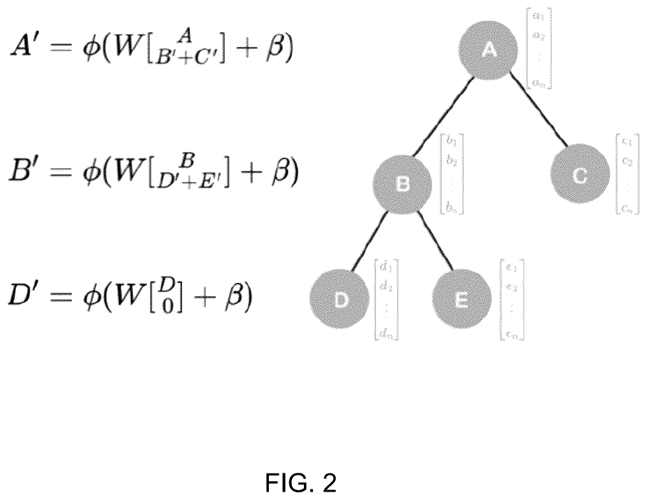

FIG. 2 shows an example of the operations performed by a graph recursive convolution layer included in a graph neural network. In the example of FIG. 2, the graph is a directed acyclic graph that include a total of five nodes A-E. The graph recursive convolution layer can perform the operations illustrated in FIG. 2 to generate an updated embedding for node A, and can perform similar operations to those illustrated in FIG. 2, e.g., in parallel with each other, to generate a respective updated embedding for each of nodes B-E included in the directed acyclic graph.

The operations include receiving, by the graph recursive convolution layer, a layer input that includes an initial embedding for each of the nodes A-E. For example, FIG. 2 illustrates that the initial embedding for node A is a vector [a₁, a₂, . . . , aₙ], initial embedding for node B is a vector [b₁, b₂, . . . , bₙ], and so on. In some implementations, the graph recursive convolution layer can receive the initial embeddings for nodes A-E from a preceding layer, e.g., a graph convolution layer or another layer, in the graph neural network. In some implementations, receiving the layer input includes receiving an initial node feature matrix. The initial node feature matrix can be a concatenation of the initial embeddings for the nodes A-E.

The operations then include making, by the graph recursive convolution layer, calls to a recursive function to traverse the directed acyclic graph. The traversal begins from a root node of the directed acyclic graph (node A), and ends until the leaf nodes of the directed acyclic graph (nodes C, D, E) are reached. A leaf node is a node in a directed acyclic graph that has no child nodes, i.e., is not connected to any other nodes by an outgoing edge.

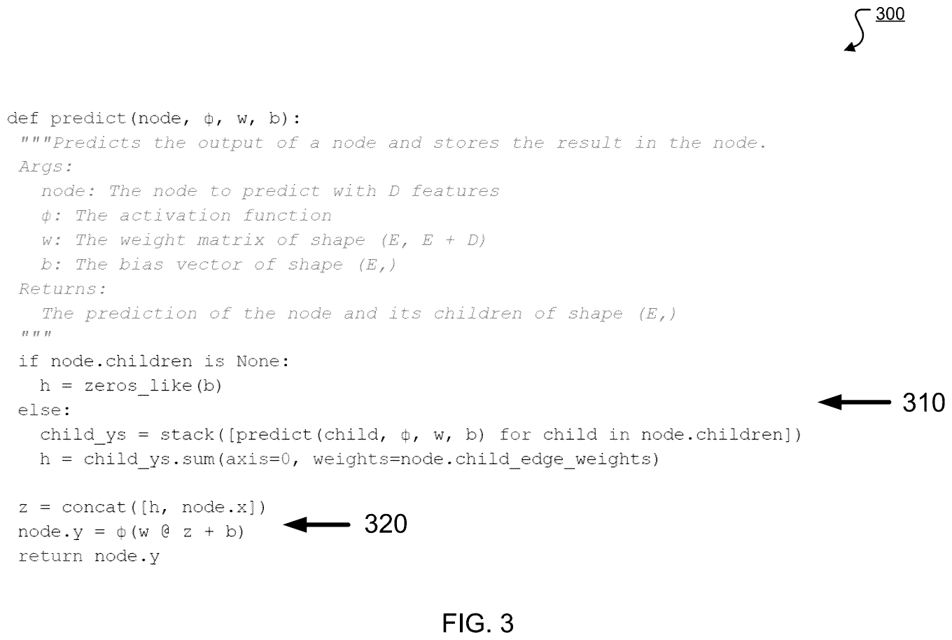

FIG. 3 shows example pseudo code to implement a recursive function 300 for a graph recursive convolution layer. The recursive function (“predict”) 300 has a recursive case 310 and a base case 320. The recursive case 310 has two conditions. One condition is that a particular node reached during the traversal is a leaf node. In this condition, the recursive function assigns a predetermined embedding to the particular node. The other condition is that a particular node reached during the traversal has one or more child nodes (that are each connected to the particular node by a respective edge). In the other condition, the recursive function calls on itself by passing each of the one or more child nodes of the particular node as an argument to the recursive function, and uses the returns from the recursive function calls to generate a combination of the updated embeddings for its child nodes. The base case 320 is the part where the function stops making recursive calls and begin to return through the recursive calls that have been made, because the particular node reached during the traversal is a leaf node.

In FIG. 2, the operations include making, by the graph recursive convolution layer, a first call to the recursive function, where the first call passes, as an argument to the recursive function, a particular node (node A) at which the traversal begins. Because node A is not a leaf node, the operations then include making, by the graph recursive convolution layer, and from within the recursive function, a second call to the recursive function, where the second call passes, as an argument to the recursive function, a child node (node B) of the particular node (node A). Likewise, the operations include making a third call to the recursive function, where the third call passes, as an argument to the recursive function, another child node (node C) of the particular node (node A). Because node B is also not a leaf node, the operations then include making a fourth call to the recursive function, where the fourth call passes, as an argument to the recursive function, a child node (node D) of the particular node (node B) reached during the traversal. Likewise, the operations include making a fifth call to the recursive function, where the fifth call passes, as an argument to the recursive function, another child node (node E) of the particular node (node B) reached during the traversal.

Because node D is a leaf node, the operations then include receiving, from the recursive function, a return for the fourth call previously made to the recursive function. The return for the fourth call to the recursive function includes the updated embedding D′ for node D, and can generated by applying Equation 2 to an input z_{D} in accordance with the activation function φ, the weight matrix W, and the bias vector b. Input z_{D} is a concatenation of a predetermined embedding and the initial embedding D=[d₁, d₂, . . . , dₙ] for node D.

In the example pseudo code of FIG. 3, the predetermined embedding has all zeros. In other examples, the predetermined embedding can have different values, e.g., all ones, or a collection of any other predetermined values, e.g., can values that are set to be equal to the initial embedding of the leaf node, or some values that can be derived from the initial embedding of the leaf node.

Likewise, because node E is a leaf node, the operations include receiving, from the recursive function, a return for the fifth call previously made to the recursive function. The return for the fifth call to the recursive function includes the updated embedding E′ for node E, and can be generated as similarly described above based on the predetermined embedding and the initial embedding E=[e₁, e₂, . . . , eₙ] for node E.

The operations further include receiving, from the recursive function, a return for the second call previously made to the recursive function. The return for the second call to the recursive function includes the updated embedding B′ for node B, and can be generated by applying Equation 2 to an input z_{B} in accordance with the activation function φ, the weight matrix W, and the bias vector b. Input z_{B} is a concatenation of (i) the initial embedding B=[b₁, b₂, . . . , bₙ] for node B and (ii) a combination of the updated embedding D′ for node D and the updated embedding E′ for node E.

In the example pseudo code of FIG. 3, such a combination is determined as a weighted summation of the updated embeddings weighted by weight terms defined by the edges that respectively connect nodes D and E to node B. In other examples, the combination can be determined in a different way, e.g., as an average, maximum, or minimum of the updated embeddings, or using more complicated weighting schemes, such as edge convolutions.

Because node C is a leaf node, the operations include receiving, from the recursive function, a return for the third call previously made to the recursive function. The return for the third call to the recursive function includes the updated embedding C′ for node C, and can be generated as similarly described above based on the predetermined embedding and the initial embedding C=[c₁, c, . . . , cₙ] for node C.

The operations further include receiving, from the recursive function, a return for the first call previously made to the recursive function. The return for the first call to the recursive function includes the updated embedding A′ for node A, and can be generated by applying Equation 2 to an input z_{A} in accordance with the activation function φ, the weight matrix W, and the bias vector b. Input z_{A} is a concatenation of (i) the initial embedding A=[a₁, a₂, . . . , aₙ] for node A and (ii) a combination of the updated embedding B′ for node B and the updated embedding C′ for node C. Note that the updated embedding for node B, in turn, is generated based on the initial embeddings for node B, node D, and node E.

Thus, unlike a graph convolution layer, by recursively applying the aggregate-and-update equation across a recursive procedure, the graph recursive convolution layer can generate an updated embedding for node A (and, analogously, any other node in the graph) based on the initial embeddings for a much larger number of nodes included in the graph. In FIG. 2, for example, the graph convolution layer would generate an updated embedding for node A based only on the initial embeddings for nodes A, B and C, whereas the graph recursive convolution layer generates an updated embedding for node A based on the initial embeddings for nodes A, B C, D, and E.

This improves the performance of the graph neural network from a variety of aspects. From one aspect, the representation power of the graph neural network is improved, because the graph recursive convolution layer has a wider receptive field for each node in the graph that incorporates a greater amount of information from a larger number of nodes included in the graph. That is, the graph recursive convolution layer incorporates information from not only the immediate neighbor nodes of a given node, but also information from distant nodes, including leaf nodes in the graph. From another aspect, the model efficiency of the graph neural network is also improved because the graph neural network can enlarge the receptive field for each layer without the need for adding more neural network layers. Hence, no additional parameters and, correspondingly, no additional memory overhead associated with storing those parameters, are added. On the other hand, expanding the receptive field in a conventional graph neural network would require adding more layers. For example, to achieve a receptive field to cover nodes connected to a given node through at most three edges, three graph convolution layers would be required. From yet another aspect, the adaptability of the graph neural network is improved because the graph recursive convolution layer is suitable for processing graphs in variable sizes.

Turning back to FIG. 1, the graph recursive convolution layer 106 generates the layer output 108 from the updated embedding has been generated for each node included in the graph. In some implementations, the layer output 108 can include an updated node feature matrix. The updated node feature matrix can be a concatenation of updated embeddings for the nodes included in the graph.

The graph neural network 110 then processes the layer output 108 of the graph recursive convolution layer 106 using other layers included in the graph neural network 110 to generate the output 112 of the graph neural network 110. Depending on the configuration of the graph neural network 110, those other layers can be configured to process the layer output 108, or data derived from the layer output 108, or both in a variety of different ways to generate the output 112, e.g., by applying a graph convolution operation, another graph recursive convolution operation, a global pooling operation, and so forth.

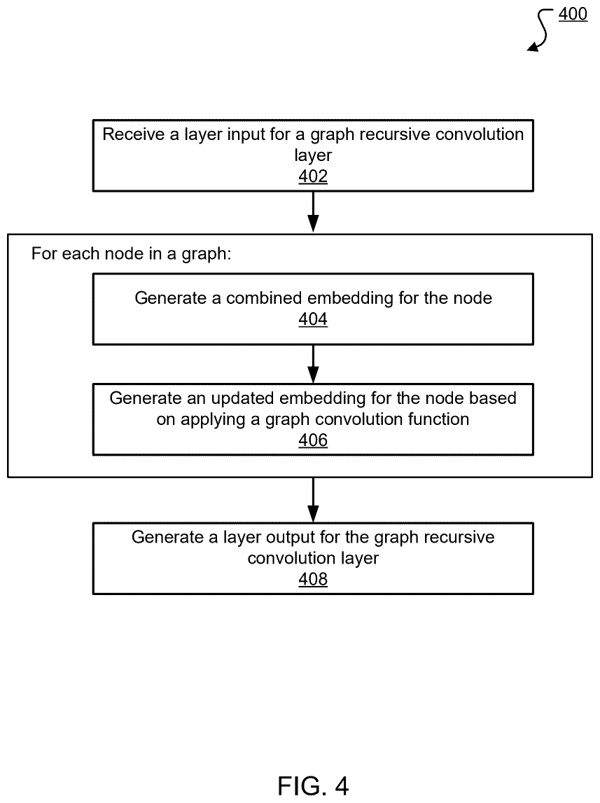

FIG. 4 is a flow diagram of an example process 400 for processing a layer input by a graph recursive convolution layer included in a graph neural network to generate a layer output. For convenience, the process 400 will be described as being performed by a system of one or more computers located in one or more locations. For example, a graph neural network system, e.g., the graph neural network system 100 of FIG. 1, appropriately programmed in accordance with this specification, can perform the process 400.

The system receives, at the graph recursive convolution layer, a layer input (step 402). The layer input includes an initial embedding for each of the plurality of nodes in a graph. The graph includes a set of nodes and a set of edges that each connect a respective pair of nodes included in the graph. In some implementations, the graph is a directed acyclic graph. The initial embeddings can be generated by a preceding layer, e.g., a graph convolution layer or another layer, in the graph neural network. Alternatively, the initial embeddings can have predetermined values that are determined by the graph recursive convolution layer.

The system repeatedly performs the following steps 304-306 for each node (referred to as the “particular node” below) in the set of nodes included in the graph to generate the updated embedding for the node.

The system generates a combined embedding for the particular node (step 404). The combined embedding is generated based on the initial embedding for the particular node and on the respective initial embeddings for one or more leaf nodes of the graph.

To generate the combined embedding for the particular node, the system makes multiple calls to a recursive function to traverse at least a portion of the graph beginning from the particular node and ending at one or more leaf nodes of the graph. This can involve making a call to the recursive function by passing the particular node as an argument to the recursive function, and then, for each node reached during the traversal (including the particular node), passing a child node of the node as an argument to the recursive function.

The system generates the combined embedding z for the particular node based on the returns for the recursive calls. For example, for the particular node, the returns for the recursive calls include the respective updated embeddings for the immediate child nodes of the particular node. The system can then generate the combined embedding z for the particular node by concatenating (i) the initial embedding x for the particular node to (ii) a combination h, e.g., a sum, average, maximum, or minimum, of the updated embeddings for immediate child nodes of the first node.

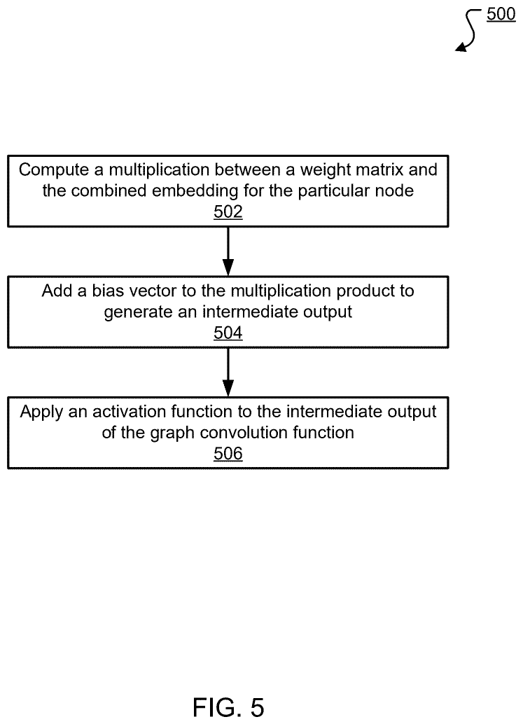

The system generates the updated embedding for the particular node by applying a graph convolution function to the combined embedding (step 406). Step 406 is explained in more detail with reference to FIG. 5, which shows sub-steps 502-506 corresponding to step 406.

The system computes a multiplication between a weight matrix W and the combined embedding z for the particular node to generate a multiplication product Wz (step 502).

The system adds a bias vector b to the multiplication product Wz to generate an intermediate output b+Wz of the graph convolution function (step 504).

The system applies an activation function (to the intermediate output of the graph convolution function to generate, as the final output of the graph convolution function, the updated embedding φ(b+Wz) for the particular node (step 506).

The system generates a layer output for the graph recursive convolutional layer from the updated embedding for each of the set of nodes included in the graph (step 408). In some implementations, the layer output can include an updated node feature matrix. The updated node feature matrix can be a concatenation of updated embeddings for the set of nodes included in the graph.

By repeatedly performing the processes 400 and 500 for each of one or more graph recursive convolutional layers in the graph neural network and then processing at least part of the layer output generated by the last graph recursive convolutional layer in the graph neural network using other layers of the graph neural network, the system can generate an output for a received input that includes graph data representing the graph.

That is, the processes 400 and 500 can be performed as part of predicting an output for an input for which the desired output, i.e., the output that should be generated by the system for the graph included in the input, is not known.

The processes 400 and 500 can also be performed as part of processing inputs derived from a set of training data, i.e., inputs derived from a set of inputs for which the output that should be generated by the system is known, in order to train the graph neural network to determine trained values for the parameters of the graph neural network.

The system can repeatedly perform processes 400 and 500 on inputs selected from a set of training data as part of a conventional graph neural network training technique to train the graph recursive convolution layer(s) and the other layers of the graph neural network, e.g., a gradient descent with backpropagation training technique that uses a conventional optimizer, e.g., an Adam, Adagrad, RMSprop, Stochastic Gradient Descent (SGD), or SGD with momentum optimizer, to optimize an objective function, e.g., a cross-entropy loss function or mean squared error (MSE) loss function, that is appropriate for the task that the graph neural network is configured to perform.

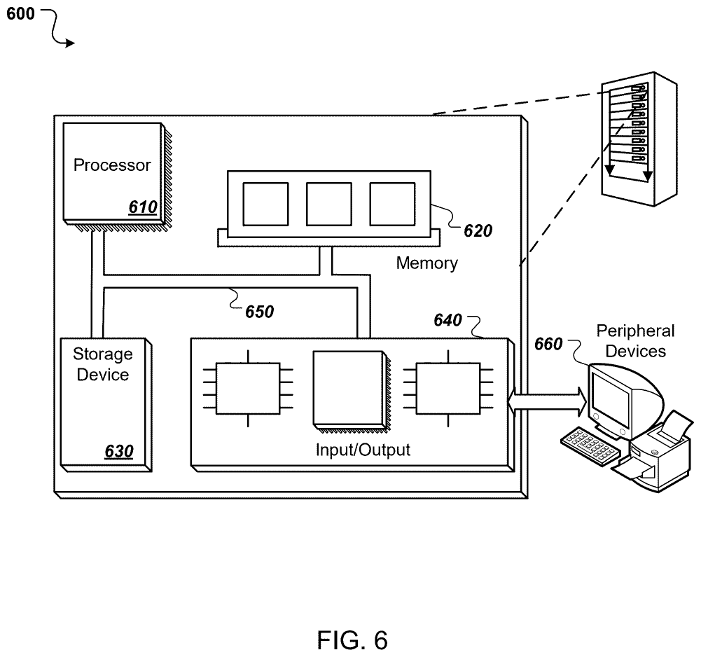

FIG. 6 is a block diagram of an example computer system 600 that can be used to perform operations described above, according to an implementation of the present disclosure. The system 600 includes a processor 610, a memory 620, a storage device 630, and an input/output device 640. Each of the components 610, 620, 630, and 640 can be interconnected, for example, using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 can include, for example, a hard disk device, an optical disk device, a storage device that is shared over a network by multiple computing devices (e.g., a cloud storage device), or some other large capacity storage device.

The input/output device 640 provides input/output operations for the system 600. In one implementation, the input/output device 640 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other devices, e.g., keyboard, printer, display, and other peripheral devices 660. Other implementations, however, can also be used, such as mobile computing devices, mobile communication devices, set-top box television client devices, etc.

Although an example processing system has been described in FIG. 6, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

This document refers to a service apparatus. As used herein, a service apparatus is one or more data processing apparatus that perform operations to facilitate the distribution of content over a network. The service apparatus is depicted as a single block in block diagrams. However, while the service apparatus could be a single device or single set of devices, this disclosure contemplates that the service apparatus could also be a group of devices, or even multiple different systems that communicate in order to provide various content to client devices. For example, the service apparatus could encompass one or more of a search system, a video streaming service, an audio streaming service, an email service, a navigation service, an advertising service, a gaming service, or any other service.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A computer-implemented method for processing data representing a graph through each of a plurality of layers of a graph neural network to generate an output, wherein the graph comprises a plurality of nodes and edges connecting the nodes, wherein the plurality of layers comprise a graph recursive convolutional layer, and wherein the method comprises:
receiving a layer input for the graph recursive convolution layer that comprises an initial embedding for each of the plurality of nodes in the graph, and, for a particular node in the plurality of nodes:
generating a combined embedding for the particular node based on an initial embedding for the particular node and on respective initial embeddings for one or more leaf nodes of the graph; and
generating an updated embedding for the particular node based on applying a graph convolution function to the combined embedding for the particular node; and
generating, from at least the updated embedding for the particular node in the plurality of nodes, a layer output for the graph recursive convolution layer.

2. The method of claim 1, wherein generating the combined embedding for the particular node comprises:
making a call to a recursive function by passing a child node of the particular node as an argument to the recursive function.

3. The method of claim 2, wherein generating the combined embedding for the particular node comprises:
making another call to the recursive function if the child node is not a leaf node in the graph.

4. The method of claim 1, wherein generating the combined embedding for the particular node comprises:
determining a combination of respective updated embeddings for child nodes of the particular node.

5. The method of claim 4, wherein determining the combination of respective updated embeddings for child nodes of the particular node comprises:
determining a weighted summation of the updated embeddings weighted by weight terms defined by edges that connect the child nodes to the particular node.

6. The method of claim 4, wherein generating the combined embedding for the particular node comprises:
concatenating the combination of respective updated embeddings for child nodes of the particular node to the initial embedding for the particular node.

7. The method of claim 1, wherein applying the graph convolution function comprises:
computing a multiplication between (i) a weight matrix and (ii) the combined embedding for the particular node to generate a multiplication product;
adding a bias vector to the multiplication product to generate an intermediate output of the graph convolution function; and
applying an activation function to the intermediate output of the graph convolution function to generate the updated embedding for the particular node.

8. The method of claim 1, wherein the graph is a directed acyclic graph.

9. The method of claim 1, further comprising:
processing the layer output for the graph recursive convolution layer using other layers in the plurality of layers to generate the output of the graph neural network.

10. The method of claim 1, wherein the other layers comprise one or more graph convolution layers and one or more pooling layers.

11. A system comprising one or more computers and one or more storage devices storing data representing a graph through each of a plurality of layers of a graph neural network to generate an output, wherein the graph comprises a plurality of nodes and edges connecting the nodes, wherein the plurality of layers comprise a graph recursive convolutional layers, and the one or more storage devices storing instructions that when executed by the one or more computers cause the one more computers to perform operations comprising:
receiving a layer input for the graph recursive convolution layer that comprises an initial embedding for each of the plurality of nodes in the graph, and, for a particular node in the plurality of nodes:
generating a combined embedding for the particular node based on an initial embedding for the particular node and on respective initial embeddings for one or more leaf nodes of the graph; and
generating an updated embedding for the particular node based on applying a graph convolution function to the combined embedding for the particular node; and
generating, from at least the updated embedding for the particular node in the plurality of nodes, a layer output for the graph recursive convolution layer.

12. The system of claim 11, wherein generating the combined embedding for the particular node comprises:
making a call to a recursive function by passing a child node of the particular node as an argument to the recursive function.

13. The system of claim 12, wherein generating the combined embedding for the particular node comprises:
making another call to the recursive function if the child node is not a leaf node in the graph.

14. The system of claim 11, wherein generating the combined embedding for the particular node comprises:
determining a combination of respective updated embeddings for child nodes of the particular node; and
concatenating the combination of respective updated embeddings for child nodes of the particular node to the initial embedding for the particular node

15. The system of claim 14, wherein determining the combination of respective updated embeddings for child nodes of the particular node comprises:
determining a weighted summation of the updated embeddings weighted by weight terms defined by edges that connect the child nodes to the particular node.

16. The system of claim 11, wherein applying the graph convolution function comprises:
computing a multiplication between (i) a weight matrix and (ii) the combined embedding for the particular node to generate a multiplication product;
adding a bias vector to the multiplication product to generate an intermediate output of the graph convolution function; and
applying an activation function to the intermediate output of the graph convolution function to generate the updated embedding for the particular node.

17. The system of claim 11, wherein the graph is a directed acyclic graph.

18. The system of claim 11, the operations further comprising:
processing the layer output for the graph recursive convolution layer using other layers in the plurality of layers to generate the output of the graph neural network.

19. The system of claim 11, wherein the other layers comprise one or more graph convolution layers and one or more pooling layers.

20. One or more non-transitory computer storage media storing data representing a graph through each of a plurality of layers of a graph neural network to generate an output, wherein the graph comprises a plurality of nodes and edges connecting the nodes, wherein the plurality of layers comprise a graph recursive convolutional layers, and the one or more non-transitory computer storage media storing instructions that when executed by the one or more computers cause the one more computers to perform operations comprising:
receiving a layer input for the graph recursive convolution layer that comprises an initial embedding for each of the plurality of nodes in the graph, and, for a particular node in the plurality of nodes:
generating a combined embedding for the particular node based on an initial embedding for the particular node and on respective initial embeddings for one or more leaf nodes of the graph, wherein generating the combined embedding for the particular node comprises: making a call to a recursive function by passing a child node of the particular node as an argument to the recursive function, and determining a combination of respective updated embeddings for child nodes of the particular node; and
generating an updated embedding for the particular node based on applying a graph convolution function to the combined embedding for the particular node;
generating, from at least the updated embedding for the particular node in the plurality of nodes, a layer output for the graph recursive convolution layer, and
processing the layer output for the graph recursive convolution layer using other layers in the plurality of layers to generate the output of the graph neural network.
